(19) United States
(12) Patent Application Publication
(10) Pub. No.: US 2023/0408323 A1
(43) Pub. Date: Dec. 21, 2023

(54) MASS ESTIMATION METHODS AND SYSTEMS

(71) Applicant: GM GLOBAL TECHNOLOGY OPERATIONS LLC, Detroit, MI (US)

(72) Inventors: Ziqiang Sheng, Troy, MI (US); Kleber M Cabral, Auburn Hills, MI (US)

(73) Assignee: GM GLOBAL TECHNOLOGY OPERATIONS LLC, Detroit, MI (US)

(21) Appl. No.: 17/807,881

(22) Filed: Jun. 21, 2022

(51) Int. Cl. G01G 19/414; G01N 9/00

(52) U.S. Cl. CPC G01G 19/414; G01N 9/00

(57) ABSTRACT

In accordance with various embodiments, methods and systems are provided for estimating the mass of a numerically formed sheet metal panel. In one embodiment, a method includes: receiving, by a processor, a component data file that includes data that defines a geometry of a sheet metal component; generating, by the processor, element data based on the component data file, wherein the element data defines a plurality of elements of the component; determining, by the processor, a mass of each element of the plurality of elements based on the element data; determining, by the processor, a component mass based on a summation of the masses of the plurality of elements; and generating, by the processor, component mass data for display or design based on the determined component mass.

### INTRODUCTION

The technical field generally relates to the field of manufacturing system design and implementation, more specifically, to methods and systems for estimating the mass of a numerically formed sheet metal panel.

Obtaining an accurate mass of a vehicle component is important for vehicle design and performance. For example, accurate mass estimations assist designers in achieving certain fuel economy for the vehicle.

During product design, a sheet metal part is generally modelled with uniform thickness. However, due to metal forming processes, the thickness of sheet metal parts varies spatially. For example, thinning may be experienced on a portion experiencing stretching, while thickening may be experienced on a portion experiencing compression. For an accurate mass calculation, such thickness variations should be considered.

Accordingly, it is desirable to provide methods and systems for estimating the mass of a numerically formed sheet metal panel. Furthermore, other desirable features and characteristics of the present invention will become apparent from the subsequent detailed description of the invention and the appended claims, taken in conjunction with the accompanying drawings and this background of the invention.

### SUMMARY

In accordance with various embodiments, methods and systems are provided for estimating the mass of a numerically formed sheet metal panel. In one embodiment, a method includes: receiving, by a processor, a component data file that includes data that defines a geometry of a sheet metal component; generating, by the processor, element data based on the component data file, wherein the element data defines a plurality of elements of the component; determining, by the processor, a mass of each element of the plurality of elements based on the element data; determining, by the processor, a component mass based on a summation of the masses of the plurality of elements; and generating, by the processor, component mass data for display or design based on the determined component mass.

In various embodiments, the element data for an element of the plurality of elements include node data for each node associated with the element and thickness data associated with each node.

In various embodiments, the plurality of elements correspond to faces of a mesh file of the sheet metal component.

In various embodiments, the faces include at least one of a triangle defined by three nodes, and a quadralateral defined by four nodes.

In various embodiments, the method includes determining an area of the element of the plurality of elements; determining an average thickness of the element of the plurality of elements, and wherein the determining the mass of each element is based on the area and the average thickness.

In various embodiments, the determining the area is based on heron's formula.

In various embodiments, the determining the mass of each element is based on a density of a material of the component.

In various embodiments, the method includes receiving the density from user input.

In various embodiments, the method includes determining the density from the component data file.

In various embodiments, the method includes determining a percent difference between a nominal mass of the sheet metal component and the determined component mass; and the component mass data includes the percent difference.

In another embodiment, a system includes: a non-transitory computer readable medium that stores element data that defines a plurality of elements of a sheet metal component; and a processor coupled to the non-transitory computer readable medium. The processor is configured to: receive a component data file that includes data that defines a geometry of a component; generate the element data based on the component data file; determine a mass of each element of the plurality of elements based on the element data; determine a component mass based on a summation of the masses of the plurality of elements; and generate component mass data for display or design based on the determined component mass.

In various embodiments, the element data for an element of the plurality of elements comprises node data for each node associated with the element and thickness data associated with each node.

In various embodiments, the plurality of elements correspond to faces of a mesh file of the sheet metal component.

In various embodiments, the faces comprise at least one of a triangle defined by three nodes, and a quadralateral defined by four nodes.

In various embodiments, the processor is further configured to determine an area of the element of the plurality of elements; determine an average thickness of the element of the plurality of elements, and wherein the processor determines the mass of each element based on the area and the average thickness.

In various embodiments, the processor is further configured to determine the area based on heron's formula.

In various embodiments, the processor is further configured to determine the mass of each element based on a density of a material of the component.

In various embodiments, the processor is further configured to receive the density from user input.

In various embodiments, the processor is further configured to determine the density from the component data file.

In various embodiments, the processor is further configured to determine a percent difference between a nominal mass of the component and the determined component mass; and the component mass data includes the percent difference.

### DESCRIPTION OF THE DRAWINGS

The present disclosure will hereinafter be described in conjunction with the following drawing figures, wherein like numerals denote like elements, and wherein:

FIG. 1 is a functional block diagram of a computer system for use in sheet metal part mass estimation for manufacturing, in accordance with various embodiments;

FIG. 2 is a dataflow diagram of a mass estimation system that may be incorporated into the computer system of FIG. 1, in accordance with various embodiments; and

FIG. 3 is a flowchart of a process for computing mass that can be implemented in connection with the systems of FIGS. 1 and 2, in accordance with various embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

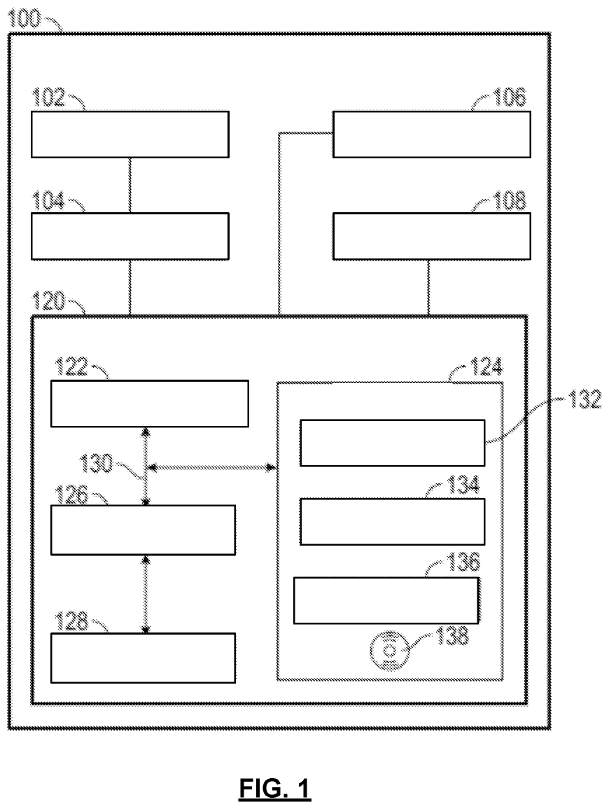

FIG. 1 is a functional block diagram of a design system (also referred to herein as the “system”) 100 for use in manufacturing elements with sheet metal, in accordance with various embodiments. The system 100 may be utilized in estimating a resulting mass of a component formed of sheet metal. While the examples herein are discussed in the context of components being associated with a vehicle, such as a body panel, the present disclosure is applicable to other components formed of sheet meal and is not limited to the present examples.

With reference to FIG. 1, in various embodiments the design system 100 includes an input device 102, input sensors 104, a display 106, and a computer system 120. Also as depicted in FIG. 1, in certain embodiments the design system 100 includes one or more transceivers 108 and/or other devices and/or components.

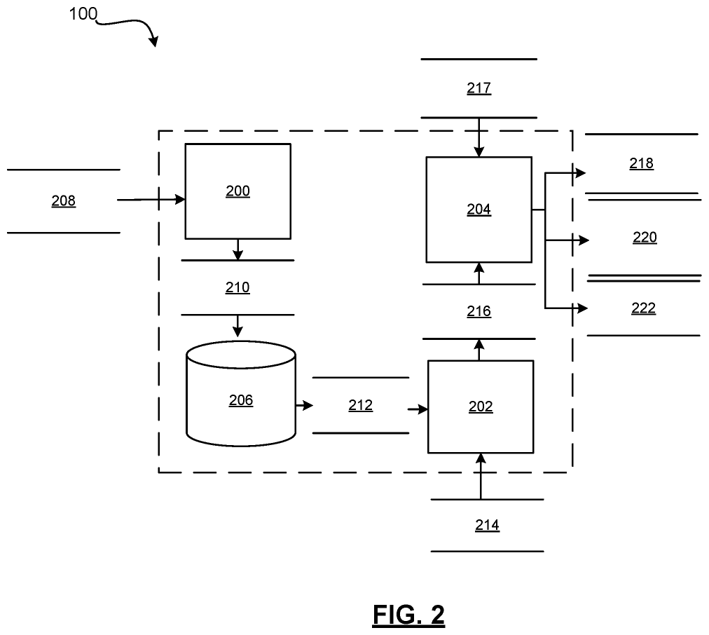

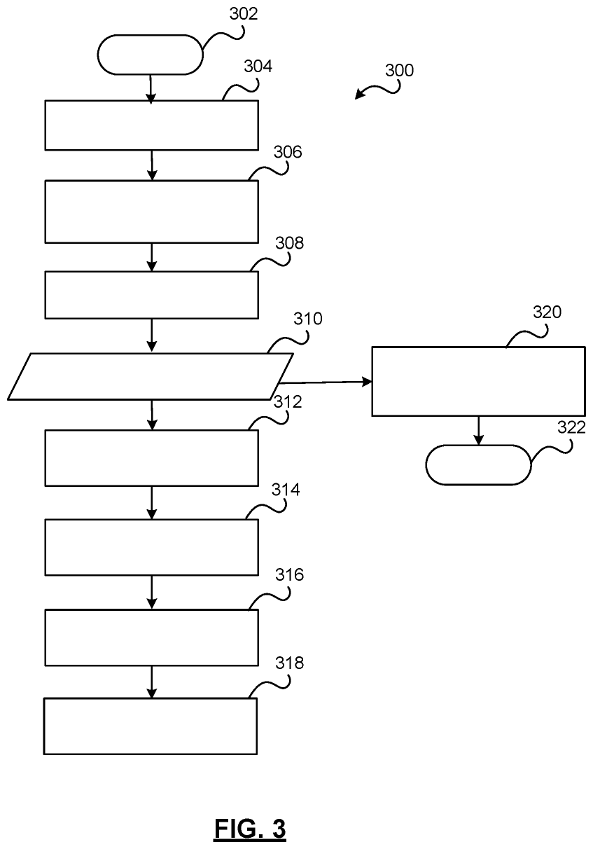

In various embodiments, the user input device 102 is configured to be utilized by one or more users involved in the design of the component. Also in various embodiments, the user input device 102 allows the user the opportunity to select different parameters. For example, as described in greater detail further below in connection with FIGS. 2-3, in various embodiments the user input device 102 collects user inputs as to parameters associated with a component of design.

In various embodiments, the user input device 102 may comprise any number of different types of devices and/or combinations thereof. For example, in certain embodiments, the input device 102 may comprise one or more touch screens, keyboards, computer mice, joysticks, buttons, knobs, dials, microphones, and/or any number of other different types of input devices and/or combinations thereof. Also in various embodiments, the input sensors 104 are coupled to and/or integrated with the input device 102. In various embodiments, the input sensors 104 detect, measure, and/or record inputs provided by the user via the input device 102.

In various embodiments, the display 106 provides a display and/or other notification to the user as to the estimated values associated with the component. In various embodiments, the display 106 may include one or more display screens and/or other displays that provide a visual display for the user. Also in certain embodiments, the display 106 may comprise one or more speakers that provide an audio notification for the user. In certain embodiments, the display 106 may comprise one or more actuators and/or other devices that provide haptic and/or other notifications for the user. In certain embodiments, the display 106 may be part of and/or coupled with the input device 102 and/or the input sensors 104; however, this may vary in other embodiments.

As noted above, in certain embodiments, the system 100 may also include a transceiver 108. In certain embodiments, the transceiver 108 (and/or a receiver thereof) may receive user inputs and/or other data used for design. In addition, in certain embodiments, the transceiver 108 (and/or a transmitter thereof) may also be utilized in providing notifications to the user (e.g., as to the results of the determinations of the computer system 120).

As depicted in FIG. 1, in various embodiments, the computer system 120 comprises a processor 122, a memory 124, an interface, a storage device 128, a bus 130, and a disk 138. In certain embodiments, the computer system 120 may also include the user input device 102, input sensors 104, display 106, transceiver 108, and/or one or more other systems and/or components thereof. In addition, it will be appreciated that the computer system 120 may otherwise differ from the embodiment depicted in FIG. 1. For example, the computer system 120 may be coupled to or may otherwise utilize one or more remote computer systems and/or other control systems.

In the depicted embodiment, the computer system 120 includes a processor 122, a memory 124, an interface 126, a storage device 128, and a bus 130. The processor 122 performs the computation and control functions of the computer system 120, and may comprise any type of processor or multiple processors, single integrated circuits such as a microprocessor, or any suitable number of integrated circuit devices and/or circuit boards working in cooperation to accomplish the functions of a processing unit. During operation, the processor 122 executes one or more programs 132 contained within the memory 124 and, as such, controls the general operation of the computer system 120, generally in executing the processes of systems described herein, such as the processes and system discussed further below in connection with FIGS. 2 and 3.

The memory 124 can be any type of suitable memory. For example, the memory 124 may include various types of dynamic random access memory (DRAM) such as SDRAM, the various types of static RAM (SRAM), and the various types of non-volatile memory (PROM, EPROM, and flash). In certain examples, the memory 124 is located on and/or co-located on the same computer chip as the processor 122. In the depicted embodiment, the memory 124 stores the above-referenced program 132 along with a plurality of algorithms 134 and stored values 136 (e.g., including, in various embodiments, tables for implementing the system and process of FIGS. 2-3).

The bus 130 serves to transmit programs, data, status and other information or signals between the various components of the computer system 120. The interface 126 allows communications to the computer system 120, for example from a system driver and/or another computer system, and can be implemented using any suitable method and apparatus. In one embodiment, the interface 126 obtains the various data from the user input device 102, input sensors 104, display 106, transceiver 108, and/or one or more other components and/or systems. The interface 126 can include one or more network interfaces to communicate with other systems or components. The interface 126 may also include one or more network interfaces to communicate with technicians, and/or one or more storage interfaces to connect to storage apparatuses, such as the storage device 128.

The storage device 128 can be any suitable type of storage apparatus, including various different types of direct access storage and/or other memory devices. In one exemplary embodiment, the storage device 128 comprises a program product from which memory 124 can receive a program 132 that executes one or more embodiments of one or more processes of the present disclosure, such as the steps of the process 300 discussed further below in connection with FIG. 3. In another exemplary embodiment, the program product may be directly stored in and/or otherwise accessed by the memory 124 and/or one or more other disks 146 and/or other memory devices.

The bus 130 can be any suitable physical or logical means of connecting computer systems and components. This includes, but is not limited to, direct hard-wired connections, fiber optics, infrared, and wireless bus technologies. During operation, the program 132 is stored in the memory 124 and executed by the processor 122.

It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 122) to perform and execute the program. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system 120 may also otherwise differ from the embodiment depicted in FIG. 1, for example in that the computer system 120 may be coupled to or may otherwise utilize one or more remote computer systems and/or other control systems.

With reference to FIG. 2 and with continued reference to FIG. 1, a dataflow diagram illustrates elements of the design system 100 of FIG. 1 in accordance with various embodiments. As can be appreciated, various embodiments of the design system 100 according to the present disclosure may include any number of modules embedded within the memory 124 of the computer system 120 which may be combined and/or further partitioned to similarly implement systems and methods described herein. Furthermore, inputs to the design system 100 may be received from the user input device 102, the input sensors 104, the transceiver 108, other modules (not shown), and/or determined/modeled by other sub-modules (not shown). In various embodiments, the design system 100 includes a data storage module 200, an element mass determination module 202, a component mass determination module 204, and an element datastore 206.

In various embodiments, the data storage module 200 receives as input a component data file 208. The component data file 208 includes data that defines the geometry of the component. For example, in various embodiments, the component data file 208 is a mesh file that includes a collection of vertices, edges, faces, and thicknesses that defines the geometry of the component. The faces can include, for example, triangles (triangle mesh), quadrilaterals (quads), or other simple convex polygons (n-gons), or may also be more generally composed of concave polygons, or even polygons with holes.

The data storage module 200 processes the data of the component data file 208 to determine elements of the component. In various embodiments, the elements correspond to the faces. The data storage module 200 generates element data 210 based on the nodes or points associated with the faces, and the thicknesses associated with each node. The data storage module 200 stores the element data 210 in the element datastore 206.

In various embodiments, the element mass determination module 202 processes element data 212 for each element in the element datastore 206 to determine an area of the element and an average thickness of the element. For example, for each element i in the element datastore 206, when the face of the element is a triangle the element mass determination module 202 computes an area a, by computing the length is of each side s of the triangle from the node points (x1, y1), (x2, y2) as:

ls=\sqrt{(x2−x1)²+(y2−y1)²},

and computing the areas using, for example, heron's formula as:

αᵢ=\sqrt{s(s−l₁)(s−l₂)(s−₃)},

where s represents:

$$s = \frac{{l}_{1} + {l}_{2} + {l}_{3}}{2} .$$

In another example, the element mass determination module 202 determines the average thickness of the element atkᵢ as:

$${atk}_{i} = \frac{{\sum }_{1}^{m} t ( nid )}{m} ,$$

Where m represents the number of nodes, and t(nid) represents the thickness at the node.

The element mass determination module 202 then computes a mass of the element based on the computed area and the computed average thickness. For example, the element mass determination module 202 computes the mass of the element eMᵢ as:

eMᵢ=αᵢ* atkᵢ*ρ,

Where ρ represents the density of the material used to create the component. In various embodiments, the density of the material may be input by a user or extracted from the component data file 208 as material data 214. The element mass determination module 202 generates element mass data 216 based on the computed mass.

The component mass determination module 204 receives as input the element mass data 216 for each element. The component mass determination module 204 computes a component mass based on a summation of the masses of all the elements of the component. In various embodiments, the component mass determination module 204 computes a percent difference between a nominal mass and the computed component mass. In various embodiments, the nominal mass may be entered by a user or extracted from the component data file 208 as nominal mass data 217. The component mass determination module 204 generates display data that includes the computed mass data 218, the nominal mass data 220, and/or the percent difference data 222 for display to a user and/or for further analysis.

With reference now to FIG. 3, a flowchart of a process 300 for estimating mass is shown in accordance with various embodiments. The process 300 can be implemented in connection with the system 100 of FIG. 1. The process 300 is described in detail in connection with FIG. 3 as well as in connection with FIG. 2.

As explained in greater detail below, in various embodiments, the process 300 provides estimation methods for estimating mass of a sheet metal component. As depicted in FIG. 3, in various embodiments the process 300 begins at 302. In certain embodiments, the process 300 begins when a user calls for the process 300 to begin operation, for example as the design of the element is begun or as a desire for the component mass is indicated.

In various embodiments, the component description file is received at 304. The element information including the nodal information and thickness information are extracted from the file at 306, and stored in a datastore at 308.

Thereafter, the element information for each element is read from the datastore at 310 and a mass is computed for the element at 312-316. For example, the area of the element is computed at 312, for example, as discussed above. The average thickness of the element is computed at 314, for example, as discussed above. The mass of the element is computed at 316, for example, as discussed above.

The total mass of the component is then computed by summing the computed mass of the elements at 318. The method continues until all of the elements of the component have been processed at 310. Once all of elements have been processed, the total mass data is then generated at 320 for display and/or other use in the design and manufacturing process. The process 300 may end at 322.

It will be appreciated that the methods and systems may vary from those depicted in the Figures and described herein. For example, in various embodiments, the design system 100 and/or other components may differ from those depicted in FIGS. 1 and 2 and/or described above in connection therewith. It will also be appreciated that the steps of the process 300 may differ, and/or that various steps thereof may be performed simultaneously and/or in a different order, than those depicted and/or described above.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method, the method comprising:
receiving, by a processor, a component data file that includes data that defines a geometry of a sheet metal component;
generating, by the processor, element data based on the component data file, wherein the element data defines a plurality of elements of the sheet metal component;
determining, by the processor, a mass of each element of the plurality of elements based on the element data;
determining, by the processor, a component mass based on a summation of the masses of the plurality of elements; and
generating, by the processor, component mass data for display or design based on the determined component mass.

2. The method of claim 1, wherein the element data for an element of the plurality of elements comprises node data for each node associated with the element and thickness data associated with each node.

3. The method of claim 1, wherein the plurality of elements correspond to faces of a mesh file of the sheet metal component.

4. The method of claim 3, wherein the faces comprise at least one of triangle defined by three nodes and a quadralateral defined by four nodes.

5. The method of claim 1, further comprising determining an area of the element of the plurality of elements; determining an average thickness of the element of the plurality of elements, and wherein the determining the mass of each element is based on the area and the average thickness.

6. The method of claim 5, wherein the determining the area is based on heron's formula.

7. The method of claim 1, wherein the determining the mass of each element is based on a density of a material of the component.

8. The method of claim 7, further comprising receiving the density from user input.

9. The method of claim 7, further comprising determining the density from the component data file.

10. The method of claim 1, further comprising determining a percent difference between a nominal mass of the sheet metal component and the determined component mass; and the component mass data includes the percent difference.

11. A system, the system comprising:
a non-transitory computer readable medium that stores element data that defines a plurality of elements of a sheet metal component; and
a processor coupled to the non-transitory computer readable medium and configured to:
receive a component data file that includes data that defines a geometry of the sheet metal component;
generate the element data based on the component data file;
determine a mass of each element of the plurality of elements based on the element data;
determine a component mass based on a summation of the masses of the plurality of elements; and
generate component mass data for display or design based on the determined component mass.

12. The system of claim 11, wherein the element data for an element of the plurality of elements comprises node data for each node associated with the element and thickness data associated with each node.

13. The system of claim 11, wherein the plurality of elements correspond to faces of a mesh file of the sheet metal component.

14. The system of claim 13, wherein comprise at least one of triangle defined by three nodes and a quadralateral defined by four nodes.

15. The system of claim 11, wherein the processor is further configured to determine an area of the element of the plurality of elements; determine an average thickness of the element of the plurality of elements, and wherein the processor determines the mass of each element based on the area and the average thickness.

16. The system of claim 15, wherein the processor is further configured to determine the area based on heron's formula.

17. The system of claim 11, wherein the processor is further configured to determine the mass of each element based on a density of a material of the sheet metal component.

18. The system of claim 17, wherein the processor is further configured to receive the density from user input.

19. The system of claim 17, wherein the processor is further configured to determine the density from the component data file.

20. The system of claim 11, wherein the processor is further configured to determine a percent difference between a nominal mass of the sheet metal component and the determined component mass; and the component mass data includes the percent difference.
